(19) United States
(12) Patent Application Publication
(10) Pub. No.: US 2017/0075928 A1
(43) Pub. Date: Mar. 16, 2017

(54) NEAR-DUPLICATE IMAGE DETECTION USING TRIPLES OF ADJACENT RANKED FEATURES

(71) Applicant: ABBYY Development LLC, Moscow (RU)

(72) Inventors: Sergey Fedorov, Moscow (RU); Olga Kacher, Moscow (RU)

(21) Appl. No.: 14/967,706

(22) Filed: Dec. 14, 2015

(30) Foreign Application Priority Data
Sep. 16, 2015 (RU) 2015139355

(51) Int. Cl. G06F 17/30

(52) U.S. Cl. CPC G06F 17/30271; G06F 17/30867; G06F 17/3028; G06F 17/3053; G06F 17/30256

(57) ABSTRACT

Systems and methods for detecting near-duplicate images using triples of adjacent ranked features (TARFs). An example method may include: identifying a plurality of TARFs associated with a query image, wherein each TARF comprises a blob feature point and two corner feature points; identifying, using an index of a corpus of images, an at least one candidate image having at least one TARF matching a TARF of the plurality of TARFs associated with the query image; and responsive to evaluating a filtering condition, identifying the candidate image as a near-duplicate of the query image.

### CROSS REFERENCE TO RELATED APPLICATIONS

The present application claims the benefit of priority under 35 USC 119 to Russian patent application No. 2015139355, filed Sep. 16, 2015; the disclosure of which is incorporated herein by reference in its entirety.

### TECHNICAL FIELD

The present disclosure is generally related to computer vision, and is more specifically related to systems and methods for detecting near-duplicate images in large corpus of images.

### BACKGROUND

A problem of near-duplicate image detection may arise in a variety of applications. The number of images that may be stored in a typical large-scale image retrieval system imposes challenging efficiency constraints upon the methods of detecting near-duplicate images.

### SUMMARY OF THE DISCLOSURE

In accordance with one or more aspects of the present disclosure, an example method may comprise: identifying, by a processing device, a plurality of triples of adjacent ranked features (TARFs) associated with a query image, wherein each TARF comprises a blob feature point and two corner feature points; identifying, using an index of a corpus of images, an at least one candidate image having at least one TARF matching a TARF of the plurality of TARFs associated with the query image; and responsive to evaluating a filtering condition, identifying the at least one candidate image as a near-duplicate of the query image.

In accordance with one or more aspects of the present disclosure, an example system may comprise: a memory to store an index of a corpus of images; and a processor, operatively coupled to the memory, the processor configured to: identify a plurality of triples of adjacent ranked features (TARFs) associated with a query image, wherein each TARF comprises a blob feature point and two corner feature points; identify, using the index of the corpus of images, an at least one candidate image having at least one TARF matching a TARF of the plurality of TARFs associated with the query image; and responsive to evaluating a filtering condition, identify the at least one candidate image as a near-duplicate of the query image.

In accordance with one or more aspects of the present disclosure, an example computer-readable non-transitory storage medium may comprise executable instructions to cause a processing device to: identify a plurality of triples of adjacent ranked features (TARFs) associated with a query image, wherein each TARF comprises a blob feature point and two corner feature points; identify, using an index of a corpus of images, an at least one candidate image having at least one TARF matching a TARF of the plurality of TARFs associated with the query image; and responsive to evaluating a filtering condition, identify the at least one candidate image as a near-duplicate of the query image.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example triple of adjacent ranked features (TARF), in accordance with one or more aspects of the present disclosure;

FIG. 2 schematically illustrates an example index entry based on the TARFs detected in a given image, in accordance with one or more aspects of the present disclosure;

FIG. 3 schematically illustrates a flowchart of an example method of producing a list of TARFs for a given image, in accordance with one or more aspects of the present disclosure;

FIG. 4 schematically illustrates a flowchart of an example method of creating index entries based on TARFs detected in a given image, in accordance with one or more aspects of the present disclosure;

FIG. 5 schematically illustrates a flowchart of an example method of detecting near-duplicate images of a given query image in a large corpus of images, in accordance with one or more aspects of the present disclosure; and

FIG. 6 depicts a block diagram of an illustrative computing device operating in accordance with one or more aspects of the present disclosure.

### DETAILED DESCRIPTION

Described herein are methods and systems for detecting near-duplicate images of a given query image in a large corpus of images using triples of adjacent ranked features (TARFs). Definitions of a near-duplicate image may vary depending upon the photometric and/or geometric variations that are allowed in near-duplicate images. Possible applications of the systems and methods described herein range from exact duplicate detection to retrieving images of the same scene or object, with a certain degree of invariance to the image scale, viewpoint and illumination. Various aspects of the above referenced methods and systems are described in details herein below by way of examples, rather than by way of limitation.

In an illustrative example, the task of detecting, in a large corpus of images, near-duplicate images of a given query image may be performed by an exhaustive (brute force) search involving comparing the query image with every image in the corpus. However, such a brute force approach would have an unacceptable computational complexity. In order to improve the search efficiency, the corpus of images may be indexed (which is conceptually similar to indexing texts) using certain image features, thus allowing for much more efficient index-based retrieval.

In accordance with one or more aspect of the present disclosure, an index of the corpus of images may be built using complex descriptors of certain composite local features, called Triple of Adjacent Ranked Features (TARFs). Grouping feature points into the triples provides a richer description of the local image area, as compared to a single-feature point, and captures highly-distinctive geometric features.

Blob feature point, or blob, herein refers to an image region that differs in visual properties, such as brightness or color, from surrounding regions. Thus, certain visual properties are constant or approximately constant within a blob, and all points within a blob may be considered to be similar to each other in terms of those properties.

Blobs may be detected in a given image using various methods, such as scale-invariant feature transform (SIFT), that involves defining key locations using a difference-of-Gaussians function, fitting a detailed model at each candidate location to determine the location and the scale, selecting keypoints based on measures of their stability, assigning one or more orientations to each keypoint, and producing keypoint descriptors by measuring local image gradients at the selected scale in the region around each keypoint. Other methods of detecting blob feature points include speeded-up robust features (SURF) and maximally stable extremal regions (MSER) detectors.

Corner feature point, or corner, herein refers to an image region that is the intersection of two or more edges. Thus, two or more different dominant edge directions may be found in a local neighborhood of a corner feature point.

Corners may be detected in a given image using various methods, such as a binary robust invariant scalable keypoints (BRISK) detector, that involves identifying candidate points across both the image and scale dimensions using a saliency criterion, and producing keypoint descriptors represented by binary strings that are built by concatenating the results of brightness comparison tests at characteristic directions for each keypoint.

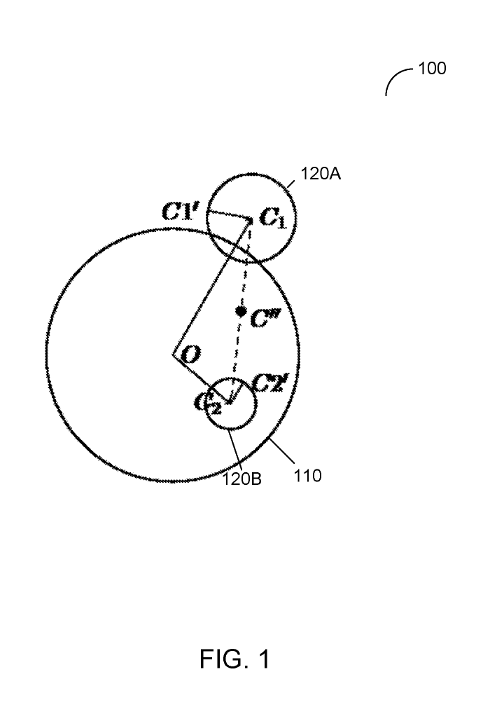

In accordance with one or more aspects of the present disclosure, one or more TARFs may be identified in an image, by detecting one or more blob feature points, and then identifying nearby corner points for each blob feature point. FIG. 1 schematically illustrates a TARF 100 comprising a blob feature point 110 having a center at 0 and two corner feature points 120A-120B having respective centers at C₁ and C₂. Vectors C₁C₁′ and C₂C₂′ schematically illustrates the detected feature directions associated with corner feature points 120A-120B, respectively. In various illustrative examples, a feature direction may be represented by the gradient of color, brightness or another visual property associated with the feature point.

However, enumerating all possible triplets may lead to a large number of combinations, most of which would not be well reproducible, as all three feature points of a TARF may not necessarily be present in a duplicate image. Thus, only the triplets that have good chances of being reproduced on a duplicate image may need to be selected among all candidate triplets. The selection process may be based on the score of corner feature points that is produced by the corner feature point detector and modified to reflect the positions of the corner feature points relative to the blob feature point. In an illustrative example, the modified score may be calculated as

S*=exp[−0.5((d−dₒ)/σ_{d})²]exp[−0.5((R_{c}−R₀)/σ_{R})²]S, (1)

wherein R_{c} is the radius of the corner feature point, d is the distance between the centers of the corner and blob feature points, and S and S* are the original and modified corner scores, respectively.

Parameters d₀, σ_{d}, R₀, and σ_{R} may be determined and/or adjusted based on experimental data. In an illustrative examples, the above listed parameters may be defined as follows:

d₀=0.5R_{b},σ_{d}=0.15R_{b},R₀=0.33R_{b}, and σ_{R}=0.15R_{b},

wherein R_{b} is the radius of the blob feature point.

In accordance with one or more aspects of the present disclosure, modified scores may be calculated using equation (1) presented herein above for a plurality of corner feature points located within a vicinity of each detected blob feature point. A pre-determined number (e.g., n*=7) of top corner feature points having the highest modified scores may be selected for each detected blob feature point.

Then, a global score threshold S₀* for the scores of corner feature points may be defined as producing a total of N₀ triplets by choosing all corner feature points whose modified score S* does not exceed the global score threshold S₀*, i.e., the corner feature points having S*<S₀*:

N₀=Σnᵢ(nᵢ−1)/2, (2)

wherein the sum is calculated for all detected blob feature points, nᵢ is the number of corner feature points in the vicinity of i-th blob feature point with modified score S* below the global score threshold S₀*, and N₀ is a parameter of the method, which in an illustrative example may be chosen from the range of 2500 . . . 3000.

For each blob feature point, a list of nᵢ<=n* top corner feature points (i.e., corner feature points having the highest modified scores) may be produced. Various combinations of a blob feature point and two different corner points from the corresponding list of top corner feature points may be identified and added to a list of TARFs associated with the given image.

As noted herein above, a large corpus of images may be indexed based on geometric properties of TARFs detected in each image. In certain implementations, for each TARF associated with a given image, three local descriptors (d_{b}, d_{c1}, d_{c2}) in the three feature points comprised by the TARF may be determined. In numerous illustrative examples, various descriptors may be employed: e.g., three BRISK descriptors, or a SIFT descriptor in the blob feature point and BRISK descriptors in the two corner feature points.

For each of the three descriptors, a visual word may be produced. In an illustrative example, K-means method may be employed for finding clusters in the descriptors space, and a descriptor may be associated to a one of these clusters, and the visual word may be derived from the identifier of the cluster. Alternatively, other method of producing visual words from descriptors may be employed. In certain implementations, the three visual words may be concatenated to produce a single integer.

In addition to the visual words, each TARF may be further characterized by certain geometric properties. Referencing FIG. 1, the geometric properties that may be determined to further characterize each TARF may include:

the angle α between OC₁ and OC₂ vectors;

the angle β₁ between OC₁ and C₁C′₁ vectors;

the angle β₂ between OC₂ and C₂C′₂ vectors;

the ratio ε₁ of the distance |OC₁| to distance |OC₂|;

the ratio ε₂ of the distance |C₁C₂| to the radius R_{b} of the blob feature point; and/or

the ratio ε₃ of the distance |OC″| to the radius R_{b} of the blob feature point, wherein C″ is the middle point of the segment |C₁C₂|.

In certain implementations, other geometric properties may be chosen, such as angles between the feature direction of the blob feature point and lines connecting the center of the blob feature points and the respective centers of the corner feature points.

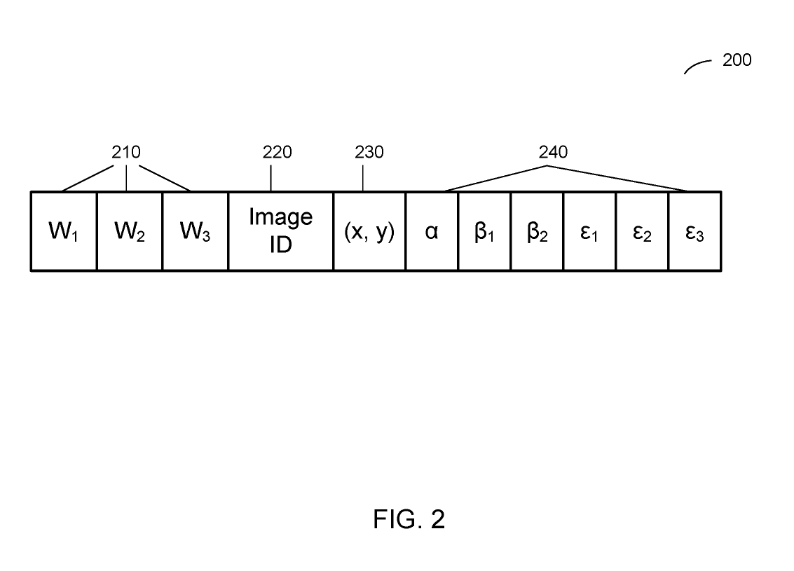

For each image of the corpus of images, a plurality of index entries may be created based on the TARFs detected in the image. Each index entry may comprise the image identifier (e.g., the name of the file containing the image), the visual words derived from the three local descriptors associated with the TARF, and one or more geometric properties associated with the TARF. In an example schematically illustrated by FIG. 2, index entry 200 comprises visual words 210, image identifier 220, coordinates of the center of the TARF 230, and geometric properties 240.

In accordance with one or more aspects of the present disclosure, the TARF-based index may be employed for detecting near-duplicate images of a given query image in a large corpus of images. A list of TARFs associated with the query image may be produced, as described in more details herein above. For each TARF of the query image, corresponding visual words and geometric properties may be produced, as described in more details herein above.

A TARF-based index of a corpus of images may be employed to identify, in the corpus of images, candidate images having at least one TARF matching a TARF of the plurality of TARFs associated with the query image. Two TARFs may be considered as matching if their visual words are identical and their geometric properties are similar (e.g., the differences between corresponding geometric properties fall within respective defined thresholds).

In certain implementations, the identified candidate images having the inverse document frequency (IDF) scores below a certain threshold may be discarded. An IDF score of a candidate image may be determined as the sum of IDF scores of the TARFs matching the query image. An IDF score of a TARF may be determined as the sum of the IDF scores of the visual words associated with the TARF. An IDF score of a visual word is the logarithmically scaled fraction of the number of images that contain the visual word.

In certain implementations, the identified candidate images may be further filtered using the random sample consensus (RANSAC) method by applying the geometric model of image transformation. Candidate images that satisfy the geometric model may be declared near-duplicates of the query image.

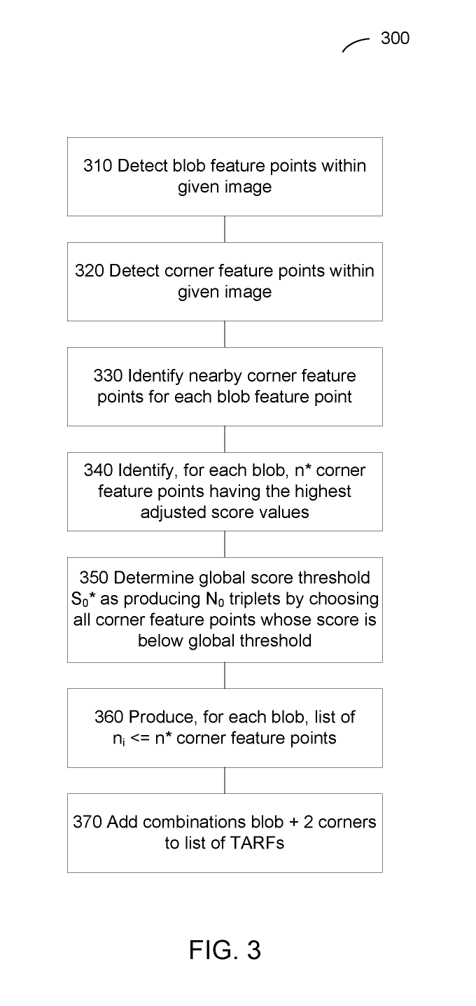

Examples of the above-referenced methods are described herein below with references to flowcharts of FIGS. 3-5.

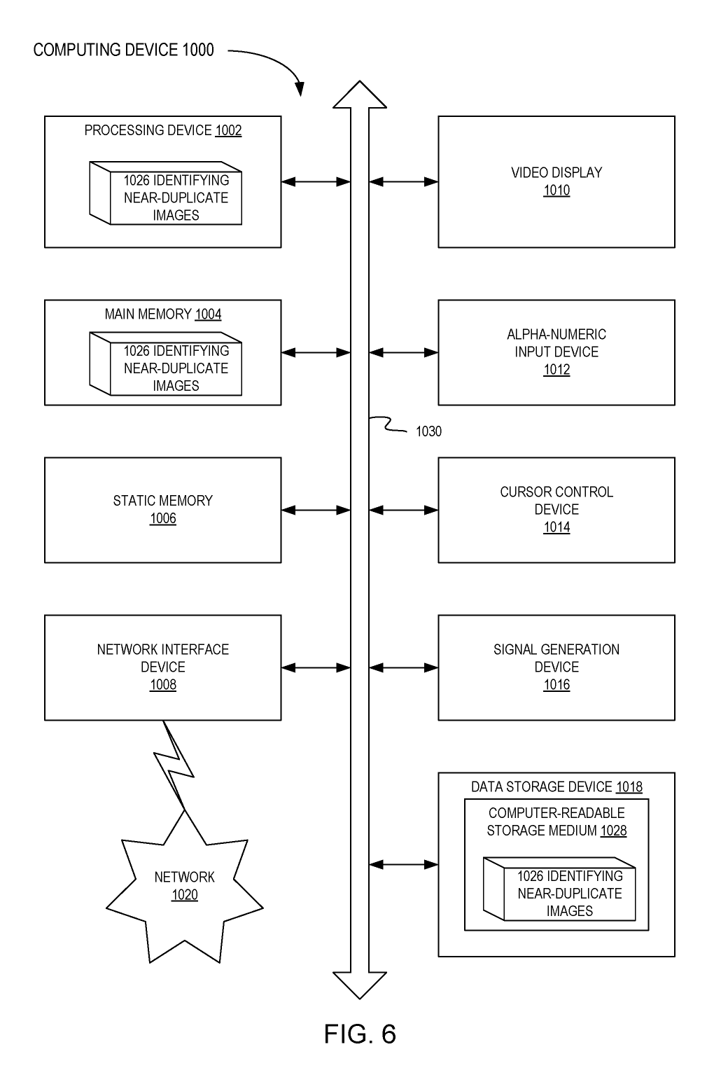

FIG. 3 depicts a flow diagram of an example method 300 of producing a list of TARFs for a given image, in accordance with one or more aspects of the present disclosure. Method 300 and/or each of its individual functions, routines, subroutines, or operations may be performed by one or more general purpose and/or specialized processing devices. Two or more functions, routines, subroutines, or operations of method 300 may be performed in parallel or in an order which may differ from the order described above. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other. In an illustrative example, method 300 may be performed by computing device 1000 described herein below with references to FIG. 6.

At block 310, a processing device implementing the method may identify a plurality of blob feature points for a given image. As noted herein above, blob feature points may be detected using various methods, such as scale-invariant feature transform (SIFT), speeded-up robust features (SURF), and/or maximally stable extremal regions (MSER) detectors. For every feature point detected, the processing device may determine the characteristic feature radius.

At block 320, the processing device may detect a plurality of corner feature points for the image. As noted herein above, corner feature points may be detected using various methods, such as a binary robust invariant scalable keypoints (BRISK) detector. For every feature point detected, the processing device may determine the characteristic feature radius.

At blocks 330-370, the processing device may enumerate a plurality of groupings of the detected feature points into TARFs, such that each TARF would comprise one blob feature point and two nearby corner feature points.

At block 330, the processing device may, for each detected blob feature point, identify a plurality of nearby corner feature points. In certain implementations, the processing device may identify a plurality of corner feature points located within a certain vicinity of the blob feature point.

At block 340, the processing device may, for each detected blob feature point, identify a pre-determined number of corner feature points having the highest modified score values. In an illustrative example, the modified score of a corner feature point may be determined using formula (1) presented herein above.

At block 350, the processing device may define a global score threshold S₀* for the scores of the corner feature points, as producing a total of N₀ triplets by choosing all corner feature points whose modified score S* does not exceed the global score threshold S₀*, i.e. corner feature points having S*<S₀*, wherein N₀ is determined using formula (3) presented herein above.

At block 360, the processing device may produce, for each detected blob feature point, a list of nᵢ<=n* top corner feature points (i.e., corner feature points having the highest modified scores), wherein nᵢ is the number of corner feature points in the vicinity of i-th blob feature point with modified score S* below the global score threshold S₀*

At block 370, the processing device may identify various combinations of a blob feature point and two different corner points from the corresponding list of top corner feature points, and add the identified combinations to a list of TARFs associated with the given image.

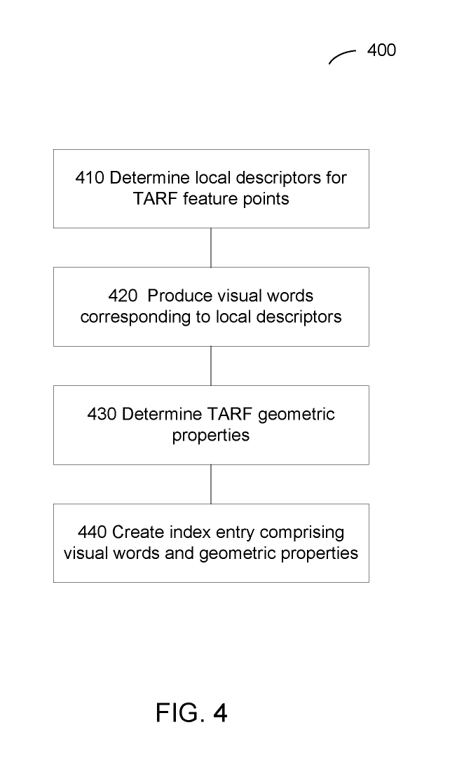

FIG. 4 depicts a flow diagram of an example method 400 of creating index entries based on TARFs detected in a given image, in accordance with one or more aspects of the present disclosure. Method 400 and/or each of its individual functions, routines, subroutines, or operations may be performed by one or more general purpose and/or specialized processing devices. Two or more functions, routines, subroutines, or operations of method 400 may be performed in parallel or in an order which may differ from the order described above. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In an illustrative example, method 400 may be performed by computing device 1000 described herein below with references to FIG. 6.

At block 410, a processing device implementing the method may determine, for each TARF associated with a given image, three local descriptors (d_{b}, d_{c1}, d_{c2}) in the three feature points comprised by the TARF, as described in more details herein above.

At block 420, the processing device may produce a visual word corresponding to each of the three descriptors, as described in more details herein above. In certain implementations, the three visual words may be concatenated to produce a single integer.

At block 430, the processing device may determine certain geometric properties for each TARF, as described in more details herein above.

At block 440, the processing device may create a plurality of index entries corresponding to the TARFs detected in the given image. Each index entry may comprise the image identifier (e.g., the name of the file containing the image), the visual words derived from the three local descriptors associated with the TARF, and one or more geometric properties associated with the TARF, as described in more details herein above. Responsive to completing operations described with respect to block 440, the method may terminate.

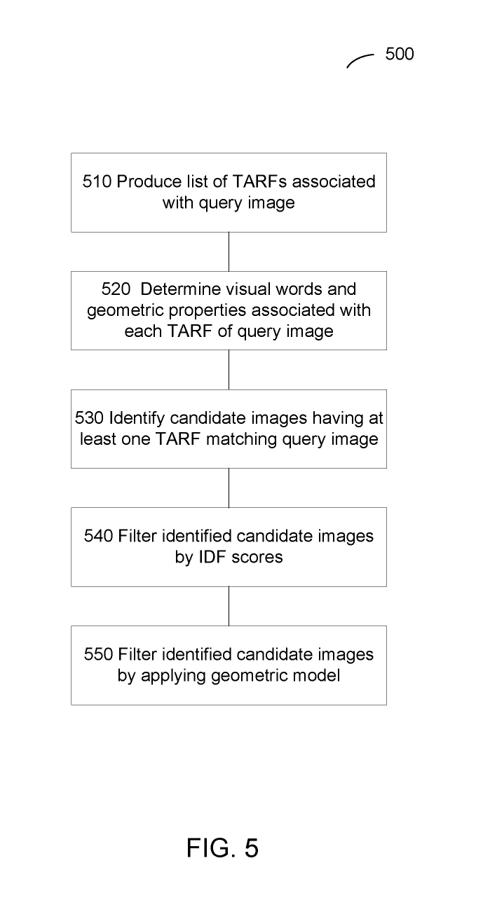

FIG. 5 depicts a flow diagram of an example method 500 of detecting near-duplicate images of a given query image in a large corpus of images, in accordance with one or more aspects of the present disclosure. Method 500 and/or each of its individual functions, routines, subroutines, or operations may be performed by one or more general purpose and/or specialized processing devices. Two or more functions, routines, subroutines, or operations of method 500 may be performed in parallel or in an order which may differ from the order described above. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other. In an illustrative example, method 500 may be performed by computing device 1000 described herein below with references to FIG. 6.

At block 510, a processing device implementing the method may produce a list of TARFs associated with the query image, e.g., by employing example method 300 described herein above.

At block 520, the processing device may determine visual words and geometric properties associated with each TARF of the query image, e.g., by employing example method 400 described herein above.

At block 530, the processing device may employ a TARF-based index of a corpus of images to identify, in the corpus of images, candidate images having at least one TARF matching a TARF of the plurality of TARFs associated with the query image. Two TARFs may be considered as matching if their visual words are identical and their geometric properties are similar (e.g., the differences between corresponding geometric properties fall within respective defined thresholds), as described in more details herein above.

At block 540, the processing device may filter the identified candidate images by their IDF scores. In an illustrative example, the identified candidate images having IDF scores that fall below a certain threshold may be discarded, as described in more details herein above.

At block 550, the processing device may further filter the identified candidate images by applying the geometric model of image transformation, as described in more details herein above. Candidate images that satisfy the geometric model may be declared near-duplicates of the query image. Responsive to completing operations described with respect to block 550, the method may terminate.

FIG. 6 illustrates a diagrammatic representation of a computing device 1000 within which a set of instructions, for causing the computing device to perform the methods discussed herein, may be executed. Computing device 1000 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 may include a processing device (e.g., a general purpose processor) 1002, a main memory 1004 (e.g., synchronous dynamic random access memory (DRAM), read-only memory (ROM)), a static memory 1006 (e.g., flash memory and a data storage device 1018), which may communicate with each other via a bus 1030.

Processing device 1002 may be provided by one or more general-purpose processing devices such as a microprocessor, central processing unit, or the like. In an illustrative example, processing device 1002 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also comprise one or more special-purpose processing devices such as an application specific integrated circuit (ASIC), a field programmable gate array (FPGA), a digital signal processor (DSP), network processor, or the like. The processing device 1002 may be configured to execute module 1026 for identifying, in a large corpus of images, near-duplicate images of a given query image by implementing methods 300, 400, and/or 500, in accordance with one or more aspects of the present disclosure, for performing the operations and steps discussed herein.

Computing device 1000 may further include a network interface device 1008 which may communicate with a network 1020. The computing device 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and an acoustic signal generation device 1016 (e.g., a speaker). In one embodiment, video display unit 1010, alphanumeric input device 1012, and cursor control device 1014 may be combined into a single component or device (e.g., an LCD touch screen).

Data storage device 1018 may include a computer-readable storage medium 1028 on which may be stored one or more sets of instructions, e.g., instructions of module 1026 for identifying, in a large corpus of images, near-duplicate images of a given query image by implementing methods 300, 400, and/or 500, in accordance with one or more aspects of the present disclosure. Instructions implementing module 1026 may also reside, completely or at least partially, within main memory 1004 and/or within processing device 1002 during execution thereof by computing device 1000, main memory 1004 and processing device 1002 also constituting computer-readable media. The instructions may further be transmitted or received over a network 1020 via network interface device 1008.

While computer-readable storage medium 1028 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method, comprising:
identifying, by a processing device, a plurality of triples of adjacent ranked features (TARFs) associated with a query image, wherein each TARF comprises a blob feature point and two corner feature points;
identifying, using an index of a corpus of images, an at least one candidate image having at least one TARF matching a TARF of the plurality of TARFs associated with the query image; and
responsive to evaluating a filtering condition, identifying the at least one candidate image as a near-duplicate of the query image.

2. The method of claim 1, wherein identifying the at least one candidate image comprises determining that each visual word of a first plurality of visual words associated with the TARF of the at least one candidate image matches a corresponding visual word of a second plurality of visual words associated with the TARF of the plurality of TARFs associated with the query image.

3. The method of claim 1, wherein identifying the at least one candidate image comprises determining that for one or more geometric properties associated with the TARF a difference between a first geometric property associated with the TARF of the candidate image and a second geometric property associated with the TARF of the plurality of TARFs associated with the query image falls below a threshold geometric property difference.

4. The method of claim 3, wherein identifying the at least one candidate image comprises determining that for each geometric property associated with the TARF a difference between a first geometric property associated with the TARF of the candidate image and a second geometric property associated with the TARF of the plurality of TARFs associated with the query image falls below a threshold geometric property difference.

5. The method of claim 1, wherein the evaluating filtering condition comprises: comparing an inverse document frequency (IDF) score of the at least one candidate image to a threshold IDF score.

6. The method of claim 1, wherein the evaluating filtering condition comprises: verifying that the transformation from the at least one candidate image to the query image satisfies a geometric model of image transformation.

7. The method of claim 1, wherein identifying the plurality of TARFs associated with the query image further comprises:
detecting a plurality of blob feature points in the query image;
detecting a plurality of corner feature points in the query image;
producing a plurality of TARFs, wherein each TARF comprises a blob feature point of the plurality of blob feature points and two corner feature points of the plurality of corner feature points.

8. The method of claim 7, wherein producing the plurality of TARFs further comprises:
for each blob feature point, identifying a plurality of corner feature points having modified score values below a threshold modified score.

9. The method of claim 1, further comprising:
building the index of the corpus of images by creating, for each image of the corpus of images, a plurality of index entries corresponding to a plurality of TARFs detected within the image.

10. The method of claim 9, wherein each index entry of the plurality of index entries comprises visual words derived from feature point descriptors associated with a corresponding TARF.

11. The method of claim 9, wherein each index entry of the plurality of index entries comprises values of one or more geometric properties associated with a corresponding TARF.

12. A system, comprising:
a memory to store an index of a corpus of images; and
a processor, operatively coupled to the memory, the processor configured to:
identify a plurality of triples of adjacent ranked features (TARFs) associated with a query image, wherein each TARF comprises a blob feature point and two corner feature points;
identify, using the index of the corpus of images, an at least one candidate image having at least one TARF matching a TARF of the plurality of TARFs associated with the query image; and
responsive to evaluating a filtering condition, identify the at least one candidate image as a near-duplicate of the query image.

13. The system of claim 12, wherein identifying the at least one candidate image comprises determining that each visual word of a first plurality of visual words associated with the TARF of the at least one candidate image matches a corresponding visual word of a second plurality of visual words associated with the TARF of the plurality of TARFs associated with the query image.

14. The system of claim 12, wherein identifying the at least one candidate image comprises determining that for one or more geometric properties associated with the TARF a difference between a first geometric property associated with the TARF of the candidate image and a second geometric property associated with the TARF of the plurality of TARFs associated with the query image falls below a threshold geometric property difference.

15. The system of claim 14, wherein identifying the at least one candidate image comprises determining that for each geometric property associated with the TARF a difference between a first geometric property associated with the TARF of the candidate image and a second geometric property associated with the TARF of the plurality of TARFs associated with the query image falls below a threshold geometric property difference.

16. The system of claim 12, wherein the evaluating filtering condition comprises: comparing an inverse document frequency (IDF) score of the at least one candidate image to a threshold IDF score.

17. The system of claim 12, wherein the evaluating filtering condition comprises: verifying that the transformation from the at least one candidate image to the query image satisfies a geometric model of image transformation.

18. The system of claim 12, wherein identifying the plurality of TARFs associated with the query image further comprises:
detecting a plurality of blob feature points in the query image;
detecting a plurality of corner feature points in the query image;
producing a plurality of TARFs, wherein each TARF comprises a blob feature point of the plurality of blob feature points and two corner feature points of the plurality of corner feature points.

19. The system of claim 12, further comprising:
building the index of the corpus of images by creating, for each image of the corpus of images, a plurality of index entries corresponding to a plurality of TARFs detected within the image.

20. A computer-readable non-transitory storage medium comprising executable instructions to cause a processing device to:
identify a plurality of triples of adjacent ranked features (TARFs) associated with a query image, wherein each TARF comprises a blob feature point and two corner feature points;
identify, using an index of a corpus of images, an at least one candidate image having at least one TARF matching a TARF of the plurality of TARFs associated with the query image; and
responsive to evaluating a filtering condition, identify the at least one candidate image as a near-duplicate of the query image.

21. The computer-readable non-transitory storage medium of claim 20, wherein identifying the at least one candidate image comprises determining that each visual word of a first plurality of visual words associated with the TARF of the at least one candidate image matches a corresponding visual word of a second plurality of visual words associated with the TARF of the plurality of TARFs associated with the query image.

22. The computer-readable non-transitory storage medium of claim 18, wherein identifying the at least one candidate image comprises determining that for each geometric property associated with the TARF a difference between a first geometric property associated with the TARF of the candidate image and a second geometric property associated with the TARF of the plurality of TARFs associated with the query image falls below a threshold geometric property difference.

22. The computer-readable non-transitory storage medium of claim 20, wherein identifying the at least one candidate image comprises determining that for one or more geometric properties associated with the TARF a difference between a first geometric property associated with the TARF of the candidate image and a second geometric property associated with the TARF of the plurality of TARFs associated with the query image falls below a threshold geometric property difference.

23. The computer-readable non-transitory storage medium of claim 22, wherein identifying the at least one candidate image comprises determining that for each geometric properties associated with the TARF a difference between a first geometric property associated with the TARF of the candidate image and a second geometric property associated with the TARF of the plurality of TARFs associated with the query image falls below a threshold geometric property difference.
